(19) United States
(12) Patent Application Publication
(10) Pub. No.: US 2015/0235574 A1
(43) Pub. Date: Aug. 20, 2015

(54) FOLDABLE LABEL AND RELATED APPARATUS

(71) Applicant: ZIH Corp., Lincolnshire, IL (US)

(72) Inventors: Thomas E. Goldblatt, Wilmette, IL (US); Kelly M. Breneisen, Antioch, IL (US)

(73) Assignee: ZIH Corp., Lincolnshire, IL (US)

(21) Appl. No.: 14/181,944

(22) Filed: Feb. 17, 2014

(51) Int. Cl. G09F 3/02; B65H 45/16; B42D 15/00

(52) U.S. Cl. CPC G09F 3/02; B42D 15/006; B65H 45/16; G09F 2003/0251

(57) ABSTRACT

A foldable label is provided that includes a first portion including a first length defined by opposing ends of the first portion and a first width defined by opposing sides of the first portion, a second portion including a second length defined by opposing ends of the second portion and a second width defined by opposing sides of the second portion, and a third portion surrounding the second portion on both sides and one end. The third portion may be attached to the second portion along both sides. The second length may be substantially equal to the first length and the second width may be substantially equal to the first width. An apparatus may be configured to receive a printed, peeled label and to facilitate the folding of the label.

### BACKGROUND

It is common practice in shipping to use a label to carry the shipping address for a package and a separate packing list to describe the package contents. Typically, the packing list is placed inside the package or in a clear plastic pouch or envelope attached by adhesive to the outside of the package. The advantage of the pouch or envelope is that information regarding the contents can be obtained without opening the package.

Several prior art inventions have combined the shipping label and packing list on a common multilayer form so they are printed simultaneously by an impact printing device that can print through multiple layers with carbons or equivalents. Others have made the shipping label and packing list co-planar for printing side-by-side or sequentially in a non-impact printer such as a thermal or laser printer. In direct thermal printing, heat is applied directly to the stock to create the printed image, and as a result direct thermal stock is more sensitive to light, heat, and abrasion than other types of stock. Thus, labels made from direct thermal stock are often susceptible to “bruising” or kinetic imaging during production, handling, and/or shipping. Unwanted images or markings on the stock may, at best, obscure the printed packing list or, at worst, make the label unusable.

### SUMMARY

Embodiments of the present invention are generally directed to adhesive labels for articles, and more particularly, to a foldable label which can be used to present a first amount of information, such as an address, while concealing a second amount of information, such as a packing slip.

According to an example embodiment, a foldable label may include a first portion with a first length defined between a fold end and a distal end of the first portion, and a first width defined between opposing sides of the first portion. The foldable label may also include a second portion including a second length defined between a fold end and a distal end of the second portion, and a second width defined by opposing sides of the second portion. The second length may be substantially equal to the first length while the second width may be substantially equal to the first width. A fold line may be defined between the first portion and the second portion proximate their respective fold ends. A third portion may be attached to the opposing sides of the second portion. Optionally, the third portion may surround and be attached to the opposing sides and the distal end of the second portion. The third portion may be attached to the second portion by a stress concentration region. The stress concentration region may include perforations. According to some embodiments, the stress concentration region may include a die-stamped region. The fold line may optionally include a stress concentration region which may include perforations, and/or the fold line may include a die-stamped region.

According to some embodiments of the present invention, the foldable label may include a fourth portion disposed between the first portion and the second portion. The fold line may extend from opposing sides of the fourth portion. The fourth portion may be attached to the second portion and the fourth portion may be separated from the first portion. The fourth portion may be attached to the second portion at a stress concentration region, which may include perforations. The first portion, the second portion, and the third portion may each include an indicia receiving major surface and a second major surface opposite the indicia receiving major surface. The second major surface of the third portion may include an adhesive. In response to the label being folded along the fold line, the second major surface of the first portion may engage the second major surface of the second portion, and the adhesive major surface of the third portion is unobstructed. The first portion and the second portion may be configured to be engaged along substantially the entire second major surface of the first portion and the second major surface of the second portion in response to the label being folded along the fold line. The second major surface of the first portion and/or the second portion may include an adhesive. According to some embodiments, the label may be disposed on a continuous backing and the label may be arranged with a plurality of other labels in at least one of a fan-fold configuration or a spool configuration. The first portion, the second portion, and the third portion may include an indicia receiving major surface that is of a material specifically adapted to receive a barcode thereon.

Some embodiments of the present invention may include a label folding apparatus with a label guide configured to be engaged by a label exiting a media processing device and to guide a first end of the label in a first direction. The label folding apparatus may also include a label stop arranged proximate to the label guide, where the first end of the label is configured to engage the label stop in response to the label being guided in a first direction, and a label grasping region disposed proximate the label guide, opposite the label stop relative to the label guide. The label grasping region may be configured to provide access to a fold line of a folded label. The label guide may include a curved surface along which the label exiting the media processing device is guided. The label grasping region may define an opening configured to present the fold line of a label to a user.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates a foldable label according to an example embodiment of the present invention;

FIG. 2 depicts an example embodiment of a peeling mechanism for peeling a label from a backing;

FIG. 3 illustrates a media processing device and a label folding aid according to an example embodiment of the present invention;

FIG. 4 illustrates the media processing device and the label folding aid of FIG. 3 as viewed from the side;

FIG. 5 illustrates the media processing device and the label folding aid of FIG. 4 with a peeled, printed label engaging the label folding aid;

FIG. 6 illustrates the media processing device and the label folding aid of FIG. 4 with a peeled, printed label further engaged with the label folding aid;

FIG. 7 illustrates the media processing device and the label folding aid of FIG. 4 with a peeled, printed label further engaged with the label folding aid;

FIG. 8 illustrates the media processing device and the label folding aid of FIG. 3 with a peeled, printed label ready for removal from the label folding aid according to an example embodiment of the present invention;

FIG. 9 illustrates a media processing device and a label folding aid according to another example embodiment of the present invention;

FIG. 10 illustrates a first side of the label of FIG. 1 peeled, printed, and folded according to an example embodiment of the present invention;

FIG. 11 illustrates a second side of the label of FIG. 1 peeled, printed, and folded according to an example embodiment of the present invention;

FIG. 12 illustrates a foldable label according to another example embodiment of the present invention;

FIG. 13 illustrates a first side of the label of FIG. 12 peeled, printed, and folded according to an example embodiment of the present invention;

FIG. 14 illustrates a second side of the label of FIG. 12 peeled, printed, and folded according to an example embodiment of the present invention; and

FIG. 15 illustrates a foldable label according to still another example embodiment of the present invention.

### DETAILED DESCRIPTION

Embodiments of the present invention now will be described more fully hereinafter with reference to the accompanying drawings in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the present invention provide a printable label that is configured to serve as both an address label and a packing list, with the packing list masked from view without removing the address label. The label is configured to be printed on a single side, and be folded into a configuration which allows for attachment to an article, such as a box or envelope, while concealing the packing list information.

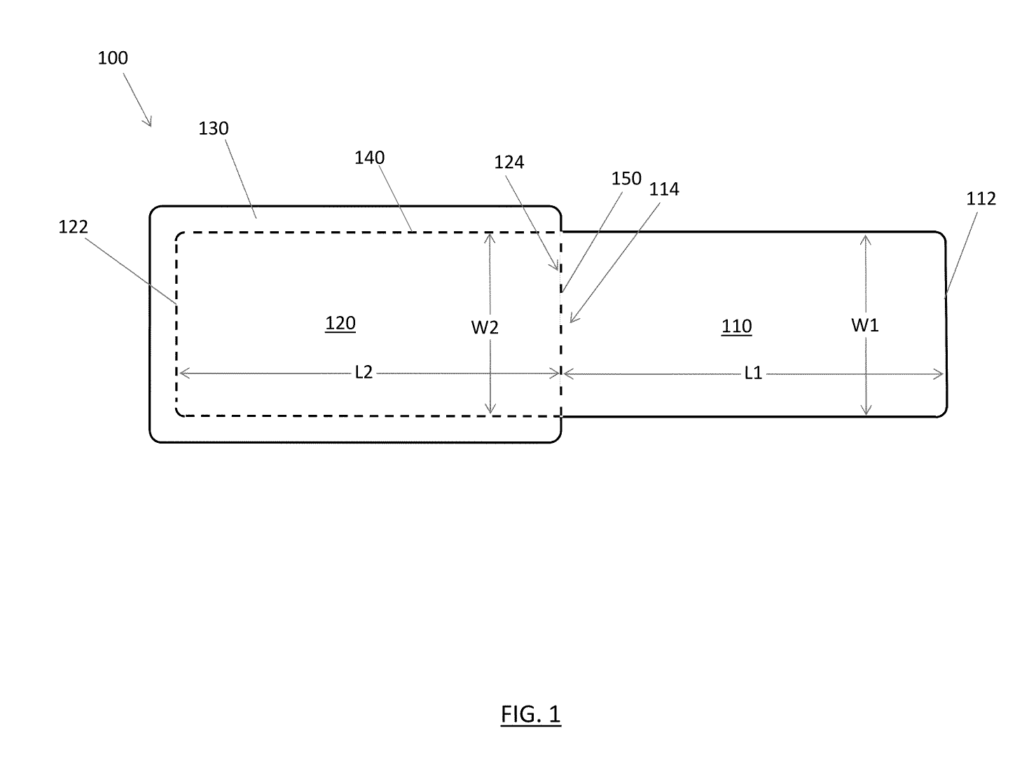

With reference to FIG. 1, a foldable label is shown according to an example embodiment. The illustrated foldable label 100 includes a first portion 110 and a second portion 120. The first portion 110 has a length of L1 extending between a distal end 112 and a fold end 114 and a width of W1 while the second portion 120 has a length of L2 extending between a distal end 122 and a fold end 124, and a width of W2. The length L1 of the first portion 110 and the length L2 of the second portion 120 are substantially equal while the width W1 of the first portion 110 and the width W2 of the second portion 120 are substantially equal. The fold end 114 of the first portion 110 is attached to the fold end 124 of the second portion 120 along fold line 150. The label 100 of the illustrated embodiment further includes a third portion 130 surrounding three sides of the second portion 120 including the distal end 122 and two opposing sides. The third portion 130 is attached to the second portion 120 along the two opposing sides of the second portion and the distal end 122 of the third portion at interface line 140.

Example embodiments of a foldable label may include a first major surface of each of the first portion 110, second portion 120, and third portion 130, configured to be printed to. The first major surface may be an ink or toner-receiving surface or a surface with a thermally responsive coating for direct-thermal printing. The first major surface, or indicia receiving major surface, may be of a material that is specifically adapted to receive thereon a barcode. While conventional papers and thermal stock may receive a barcode thereon, certain materials have been developed which resist bruising from handling pressure, provide better contrast, resist impressions from folding, and provide better heat resistance to improve the readability and reliability of a barcode. Such materials may be well suited for example embodiments of the present invention. Each of the first portion 110, second portion 120, and third portion 130 may include a second major surface, opposite the first major surface. The second major surfaces may include an adhesive coating. In an instance in which any of the second major surfaces includes an adhesive coating, the label 100 may be disposed on a liner or other carrier (referred to herein as a “backing”). The backing is typically a paper strip coated with silicone to facilitate easy removal of the adhesive backed label, commonly called the liner, but could be any other type of carrier, even a multi-layer or “piggyback” label designed for specific printing of multi-part documents. The backing may allow the label 100 to be peeled from the liner without damage to the label.

Labels of example embodiments may be supplied to a media processing device in an individual or a continuous manner. For example, a plurality of labels may be arranged consecutively on a liner wound about a core to provide a continuous spool of labels for processing. Optionally, labels may be provided on a “fan-fold” liner that provides a stack of labels in a continuous form for a media processing device. The liner of example embodiments may include black-marks, notches, or other demarcations to indicate the end of one label and/or the start of another label. These demarcations may be read by a media processing device to facilitate proper label feeding and folding.

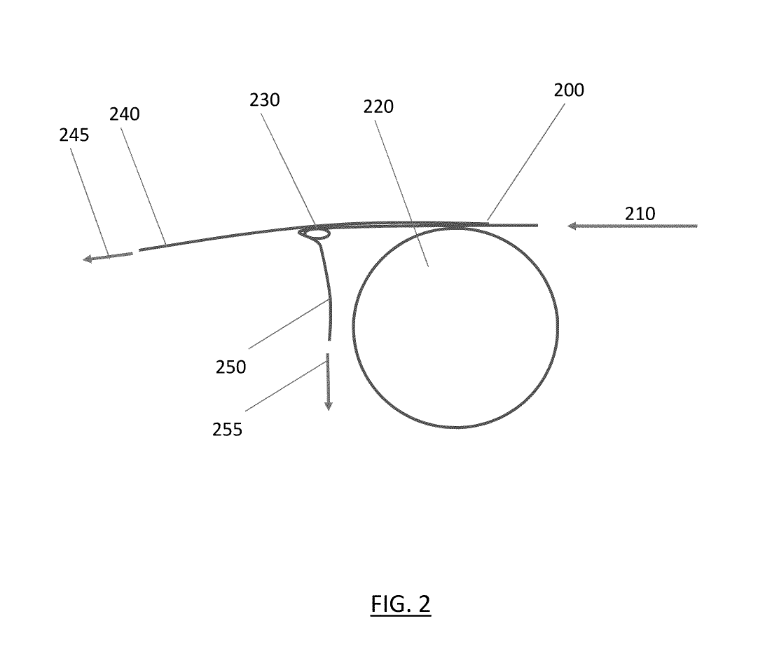

As noted above, labels of example embodiments may be disposed on a backing. When printing media on a backing, it may be desirable to have the media separated from the backing during printing rather than relying on a user to manually peel the label from the backing after printing. In such an embodiment, a media processing device configured to process labels of example embodiments may include a peeling mechanism, such as a peel bar. FIG. 2 illustrates a basic implementation of a peel bar. According to the illustrated embodiment, media 200 including the label and a backing are received at a peeling station along media feed path 210 after the media has been printed to. The media 200 may be advanced along the path by, for example, a media feed roller 220. The backing 250 may be fed around a peel bar 230 which may bend the backing 250 at an angle such that the label 240 does not continue with the backing 250, but continues to advance along label path 245 while the backing 250 advances along backing path 255. The backing 250 may initially be manually fed about the peel bar 230 when a new spool or stack of media is loaded into the media processing device, or alternatively, the backing may be automatically fed around a peel bar 230.

While example embodiments of a media processing device may be configured to print and subsequently peel media from a backing, embodiments of a media processing device may omit the printing operation in embodiments in which pre-printed labels are received by the media processing device. A media processing device may receive a pre-printed label for processing and may subsequently peel the pre-printed label in the manner described above. As such, embodiments describing a printed, peeled label herein may be directed to either labels that are printed at the media processing device, or labels that are pre-printed prior to being received at the media processing device.

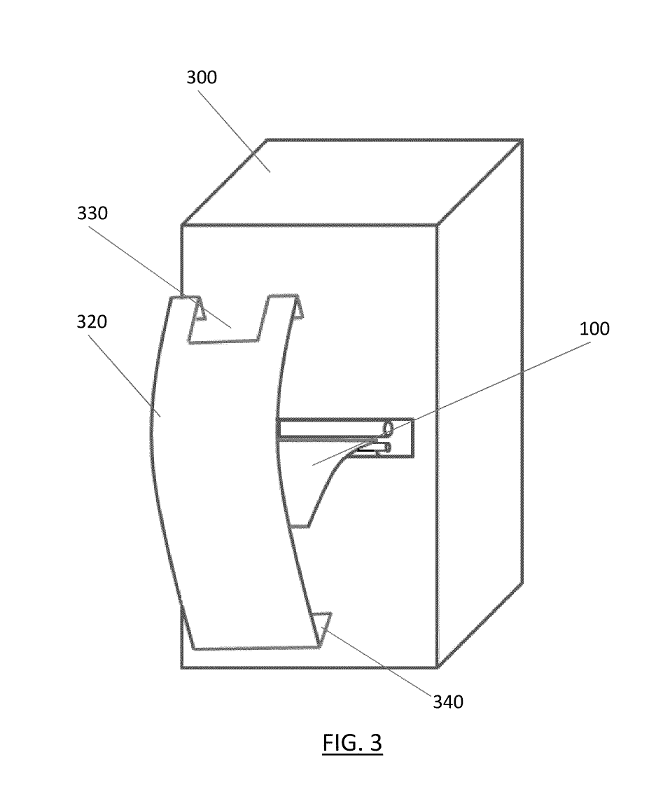

The peeling station of FIG. 2 is configured to separate the printed label 240 from the backing 250 to allow the label 240 to be folded and adhered to an article, as described further below. Provided herein is a mechanism to facilitate the folding of a label according to example embodiments. FIG. 3 depicts a media processing device 300 expelling a peeled, printed label 100. The peeled label 100 is expelled toward label folding aid 320, which may be attached to the media processing device 300 or otherwise configured to be positioned in the media exit path. The depicted label folding aid 320 includes a label stop 340 and a grasping region 330, as will be described further below. According to embodiments of the present invention, the foldable label, illustrated in FIG. 1, may exit the media processing device 300 with the third portion 130 leading. The third portion 130 and second portion 120 may exit the media processing device first and engage the label folding aid 320, as described below.

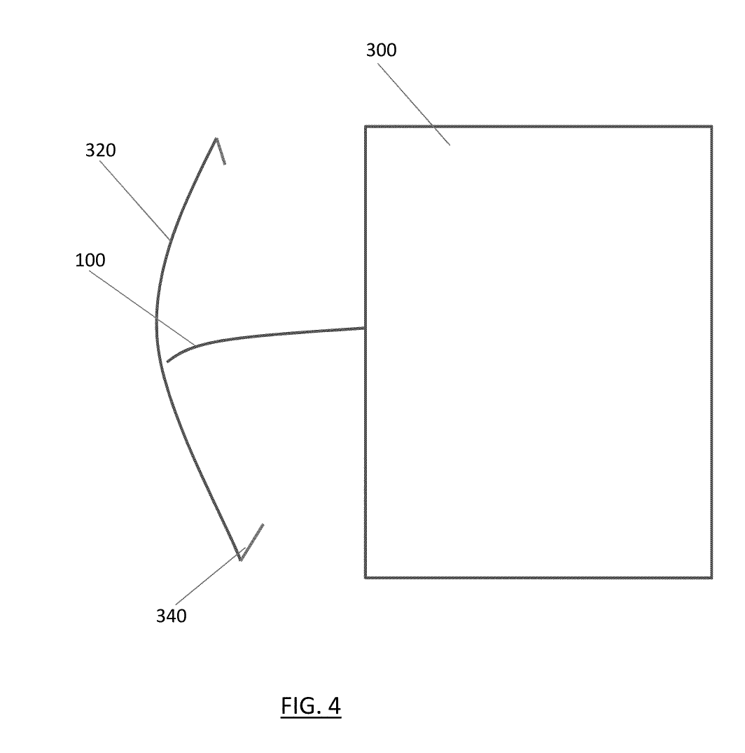

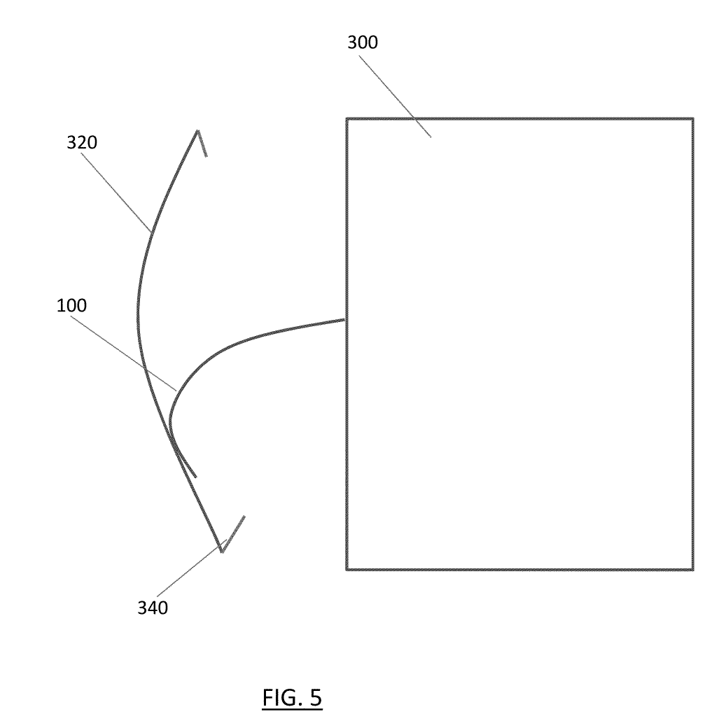

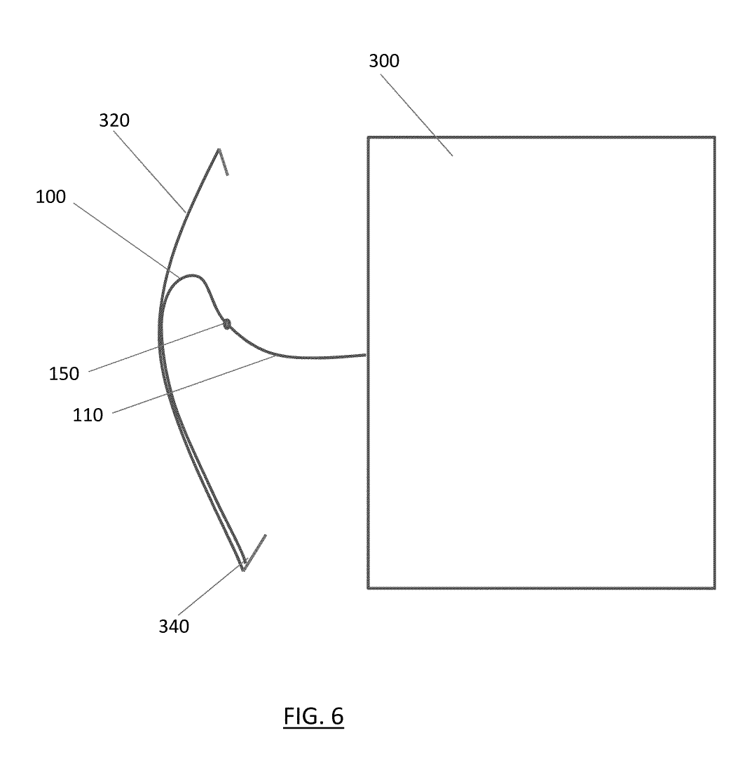

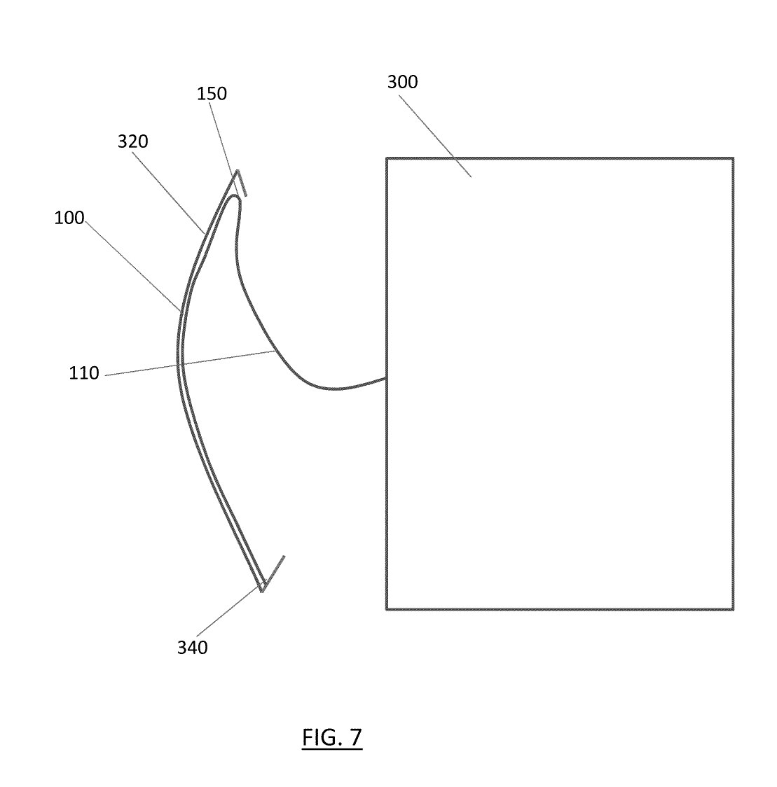

FIG. 4 illustrates a side-view of the media processing device 300 and the label folding aid 320 of FIG. 3. The third portion and the second portion of the peeled, printed label 100 exiting the media processing device 300 are received into the label folding aid 320. Upon engaging the curved surface of the label folding aid 320, the second and third portions of the peeled, printed label 100 are guided downward, toward the label stop 340. FIG. 5 illustrates the peeled label 100 guided down the label folding aid 320. When the leading edge of the peeled label 100 reaches the label stop 340, the peeled label 100 is guided up the curved surface of the label folding aid 320, as illustrated in FIG. 6. Also illustrated in FIG. 6 is the fold-line 150 disposed between the fold end 124 of the second portion 120 of the peeled label and the fold end 114 of the first portion 110 of the peeled label. The enlarged area around the fold-line 150 of the peeled label is added for illustration of the fold-line location and is not representative of an actual discontinuity in the peeled label. FIG. 7 illustrates the peeled, printed label 100 with the second 120 and third portions 130 engaged along their major, printed surface, with the label folding aid 320. The fold line 150 is disposed near the top of the label folding aid 320 proximate the label grasping region. The label folding aid is sized according to the foldable label configured to be folded therein such that a label with a leading edge engaged with the label stop 340 will have a fold line 150 that reaches the label grasping region as the label is fed from the media processing device 300 to the label folding aid 320.

As shown in FIG. 7, upon the fold line reaching the top of the label folding aid 320, the label is folded along the fold line 150 by the label folding aid 320 shape acting in concert with the first portion 110 of the label continuing to be fed from the media processing device 300. As the first portion 110 of the peeled, printed label 100 continues to be fed from the media processing device 300, the first portion 110 of the label 100 may at least partially overlay the second portion of the label that is held in the label folding aid 320.

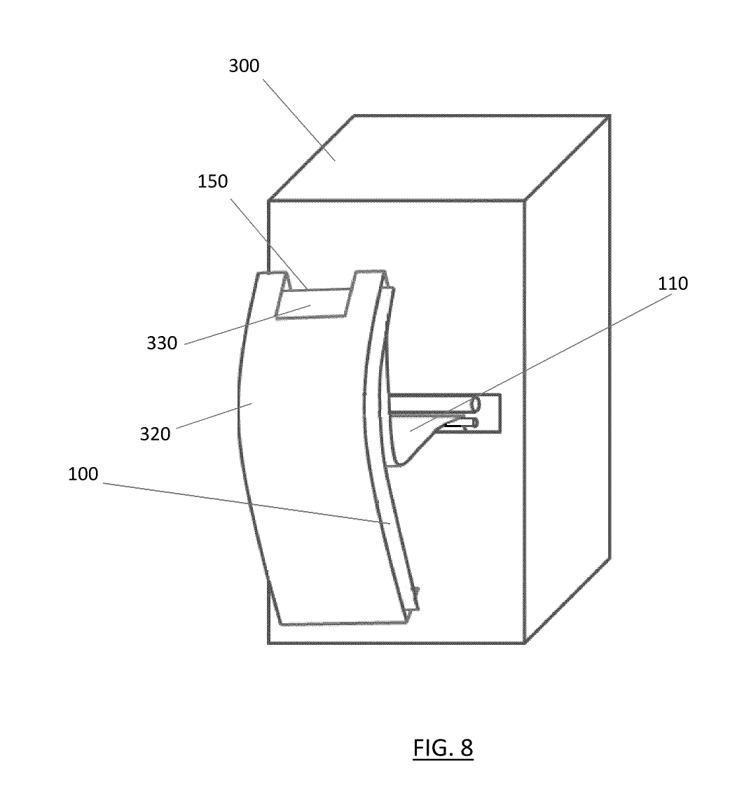

According to some embodiments, the peeled, printed label 100 is fed until the distal end 112 of the first portion 110 of the label reaches the peeling mechanism of the media processing device 300. At this point, the label may cease to be fed, awaiting the removal of the peeled, printed label from the label folding aid 320. FIG. 8 illustrates the peeled, printed label 100 in the “ready” position ready to be removed and to have the folding completed. The fold line 150 of the label 100 is disposed in the label grasping region 330 where a user may grasp the label 100 proximate the fold line 150 and remove the label 100 from the label folding aid 320 and the media processing device 300. Upon removal of the label 100 from the label folding aid 320, according to some embodiments, the first portion of the label 110 may be pressed onto the second portion of the label, adhering the first portion to the second portion, as described further below.

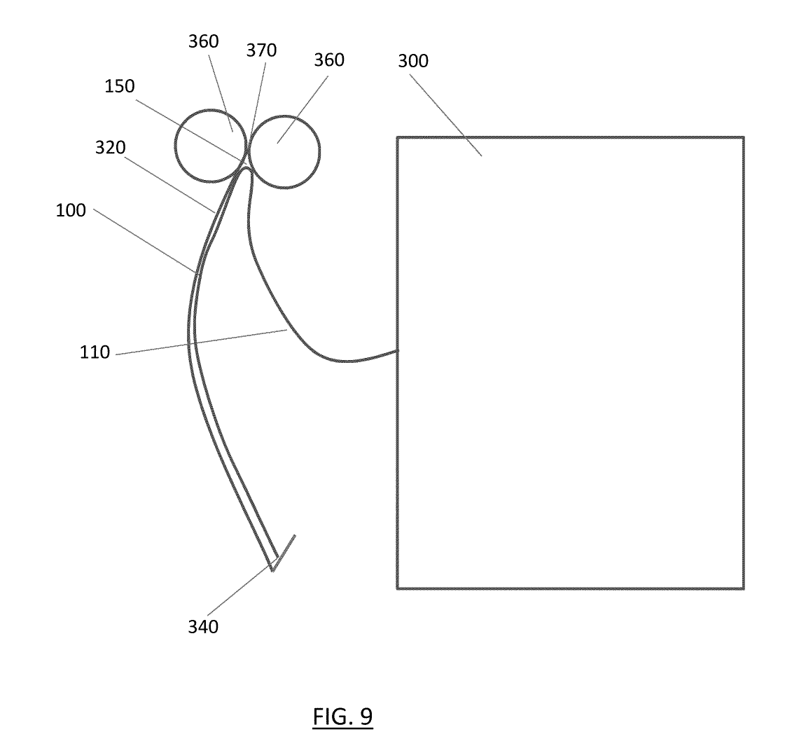

FIG. 9 illustrates another embodiment of a label folding aid according to an example embodiment. In the illustrated embodiment of FIG. 9, the label grasping region of the label folding aid 320 is replaced by a pair of rollers 360 defining a nip 370 therebetween. As the label 100 is fed to the label folding aid 320, the fold is received at the nip 370. Once the label 100 has been printed and peeled, the pair of rollers may be driven to remove the peeled, printed, and folded label from the label folding aid while also compressing the adhesive coated major surfaces of the first portion and the second portion together. The pair of rollers 360 may present the folded label to a user, or direct the label along a feed path to a position where the label may be retrieved by a user or where the label may be applied to an article by an applicator.

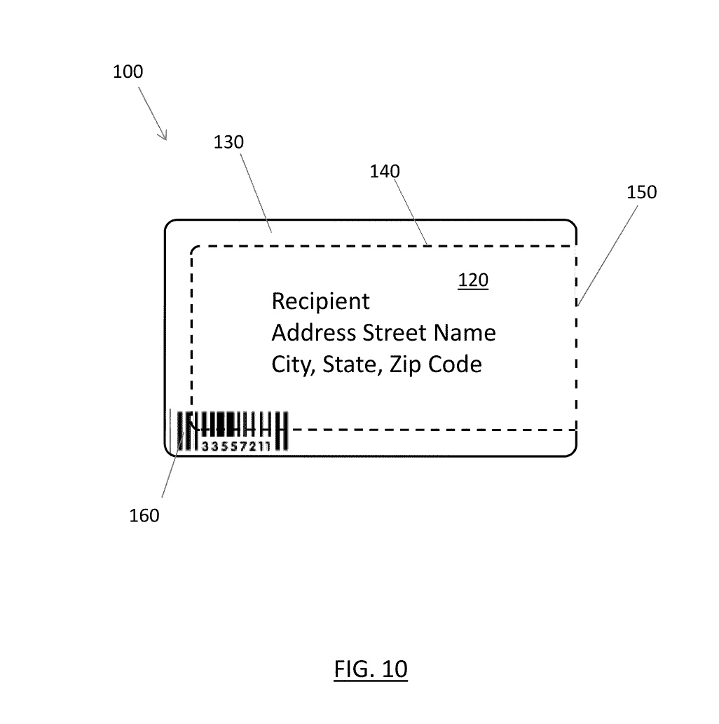

FIG. 10 illustrates the folded label of FIG. 1, as folded through the processes described with respect to FIGS. 3-9. The depicted embodiment shows the print receiving major surface of the second 120 and third portions 130. The print receiving side may include, for example, an address, a return address, a barcode 160, or any other desired characters or images. A barcode, such as barcode 160, may be printed across the interface line 140 such that when the second portion 120 is separated from the third portion 130 of the label, the barcode 160 may become unreadable. Optionally, a barcode may be printed entirely within the second portion 120 or the third portion 130, or the barcode may be printed across the interface line 140 in such a manner that the barcode can be read on the second portion 120 or the third portion 130 without both portions needing to be present.

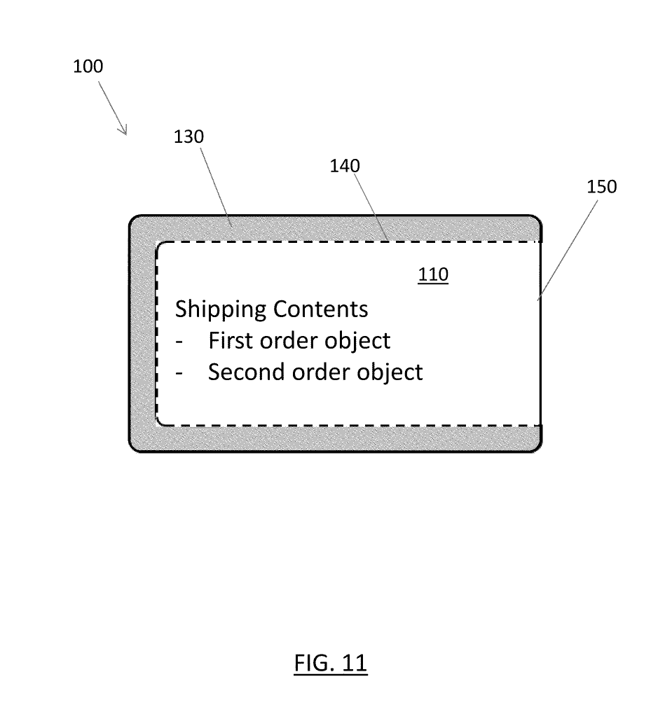

FIG. 11 illustrates the folded label of FIG. 10 viewed from the other side depicting the print receiving major surface of the first portion 110. As the first portion 110 is substantially the same width and height as the second portion 120, the first portion 110 substantially overlies the second portion 120 such that the second portion is not visible from this side. However, the adhesive coated major surface of the third portion 130 is visible and exposed along three sides of the first portion 110. The print receiving major surface of the first portion may be configured to be printed with information that is to be concealed. In the case of a shipping label, the first portion 110 may be printed with the contents of the package to which the label 100 is to be affixed, functioning as the packing slip for the package. The label 100 may be attached to an article, such as a package, by adhering the adhesive coated major surface of the third portion 130 to the package, thereby presenting the print receiving major surface of the second portion 120 while concealing the print receiving major surface of the first portion 110.

The interface line 140 between the second portion 120 and the third portion 130 may be a line of stress concentration, such as a line of perforations between the third portion 130 and the second portion 120. Optionally, the interface line 140 may be a partially cut line or an embossed line weakening the area between the second portion 120 and the third portion 130 of the label. This interface line 140 may facilitate the separation of the second portion 120 (with the first portion 110 adhered thereto) from the third portion 130. Such a configuration may allow a recipient of the package to remove first portion 110 and second portion 120 of the label 110 to view the packing slip. A user may use a finger or a tool to lift the first portion 110 and second portion 120 of the label 100 proximate the fold line 150, and proceed to tear the first portion 110 and second portion 120 from the third portion 130 by tearing at the interface line 140, which has been weakened to promote tearing at the interface line 140.

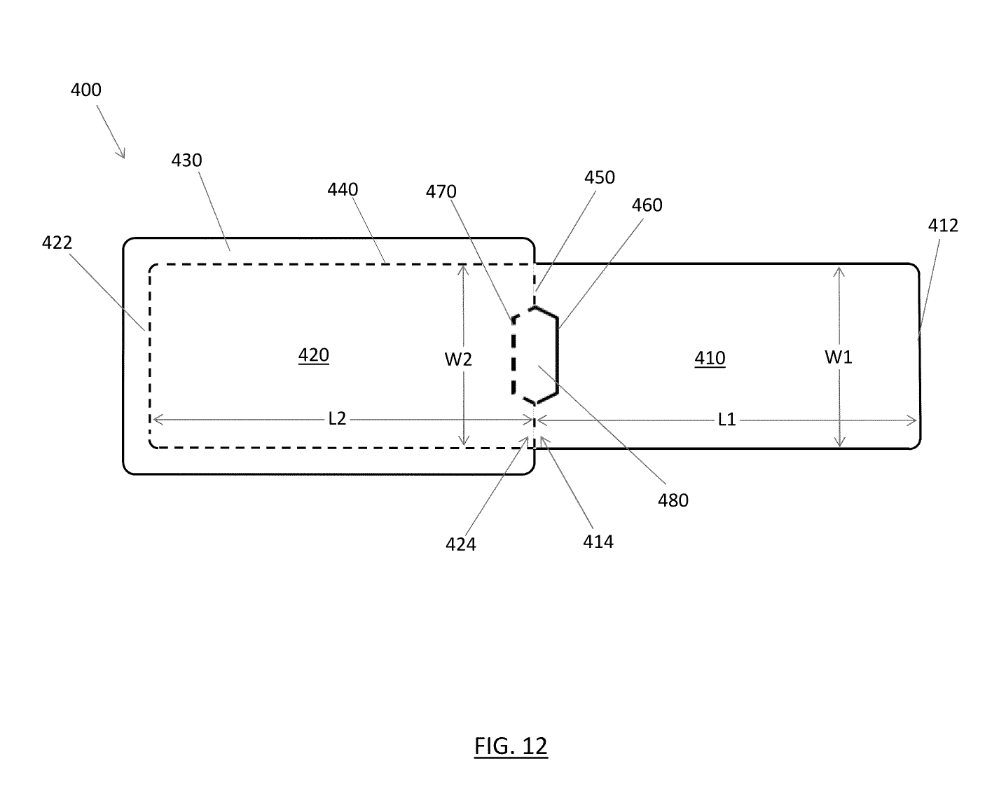

FIG. 12 illustrates another example embodiment of a foldable label 400. The embodiment of FIG. 12 is similar to that of FIG. 1, including a first portion 410, a second portion 420, and a third portion 430 of the label 400. However, the embodiment of FIG. 12 further includes a fourth portion 480. As with the embodiment of FIG. 1, the length L1 and width W1 of the first portion 410 are substantially equal to the length L2 and width W2 of the second portion 420, respectively. The length L1 is defined between the distal end 412 of the first portion 410 and the fold end 414 of the first portion, while the length L2 is defined between the distal end 422 and the fold end 424 of the second portion. The fourth portion 480 includes an area disposed along the fold line 450 with the region that lies within the first portion 410 being separated from the first portion 410 by a cut line 460 while the region of the fourth portion 480 that lies within the second portion 420 separated by an interface line 470. The fourth portion 480 is attached to the second portion 420 along interface line 470 and separated from the first portion 410 by a cut line 460.

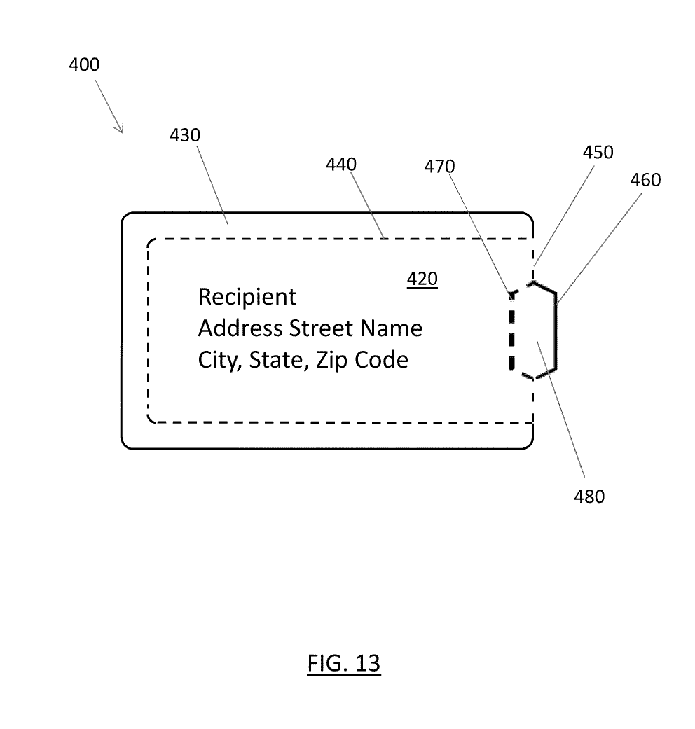

The foldable label of FIG. 12 may be configured to be folded using the same apparatus as described in FIGS. 3-9 with respect to the foldable label of FIG. 1. However, during the folding operation, the fourth portion 480 does not fold along the fold line 450. FIG. 13 illustrates the foldable label of FIG. 12 after printing, peeling, and folding as described above. FIG. 13 depicts the print receiving major surface of the second portion 420, the third portion 430, and the fourth portion 480. The fourth portion 480 remains unfolded and the cut line 460 allowed the first portion 410 to be folded at the fold line 450 while the fourth portion 480 remains unfolded.

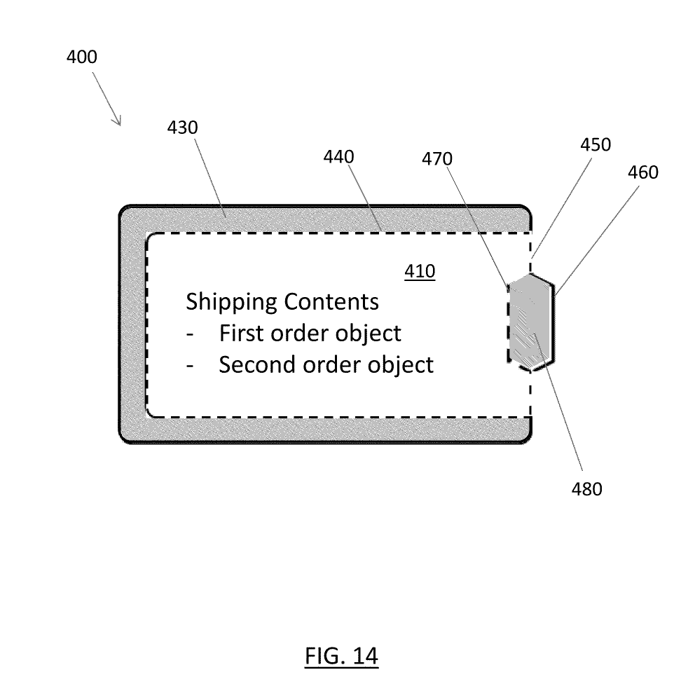

FIG. 14 illustrates the opposing side of the folded label of FIG. 13 depicting the print receiving major surface of the first portion 410 and the exposed adhesive receiving major surface of the third portion 430 and the fourth portion 480. The configuration of the foldable label of FIG. 14 allows the label 400 to be adhered to an article on all four sides of the label. The fourth portion 480 is separated from the adhered first portion 410 and second portion 420 by interface line 470, which may be a region of concentrated stress, similar to interface lines 140 and 440. The interface line 470 may be perforated, partially cut, embossed, or otherwise compromised to enable a clean tear in the removal of the adhered first portion 410 and second portion 420 from the article to which the third portion 430 and the fourth portion 480 are adhered. To remove the first portion 410 and second portion 420 from the third portion 430 and the fourth portion 480, a user may use a finger or a tool to lift the first and second portion at the fold line 450.

While embodiments of a foldable label are described herein to include a label with an adhesive coating disposed on a major surface of the various portions of the label and the label being attached to a backing, embodiments may include labels that do not require a backing. For example, a spool of media may be wound about a core without a backing such that the adhesive surface of the labels is in contact with the printable surface of other labels within the media spool. The printable surface may also be a release layer that enables the adhesive surface of the labels to be easily peeled from the printable surface as the media spool is unwound without damaging the media. Further, embodiments may include a surface that requires activation before the surface becomes adhesive. For example, a foldable label may include a print receiving surface and a back surface that has a glue disposed thereon. The glue may not become sticky until activated, such as with water, heat, shear, etc. such that a backing is not necessary. The glue may be activated after printing, ahead of the folding operation. In an instance in which a backing is not used, the foldable labels may be attached to one another to facilitate a continuous strip of media units to be processed.

Further, while the embodiments above have described a label with a first major surface for each portion that may be a print receiving surface, and a second major surface, opposite the first major surface that may be coated with adhesive, according to some embodiments, at least a portion of the second major surface may be absent adhesive. For example, according to some embodiments, the second major surface of the third portion may be coated with adhesive as a patterned adhesive. The adhesive may not be present on the second major surface of the second portion or the first portion. In such an embodiment, the printed, peeled label, when folded, will still adhere to an article through the adhesive of the third portion; however, the first portion and the second portion may not be adhered together.

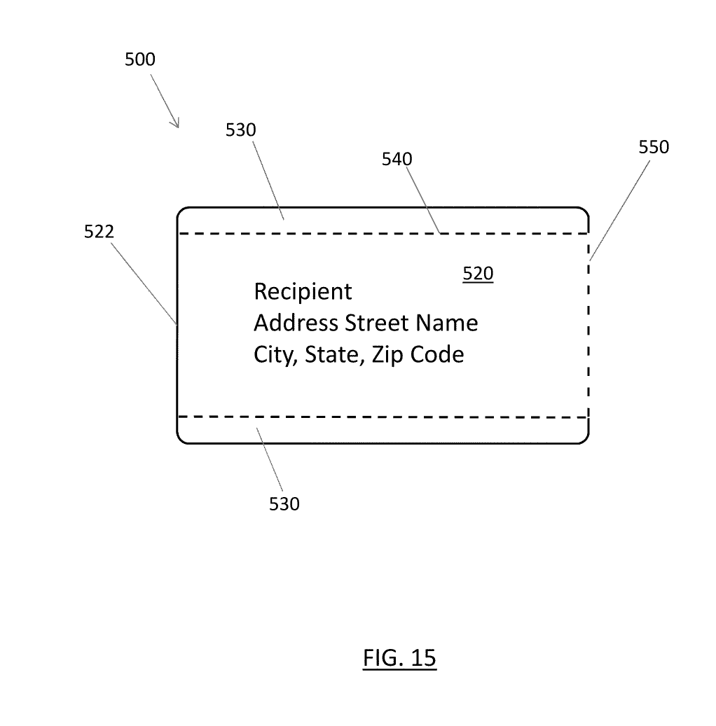

FIG. 15 illustrates another example embodiment of a label 500 according to the present invention. The illustrated embodiment of a label 500 is depicted in the folded configuration, with the first portion folded behind the second portion 520 at fold line 550. As shown, the third portion 530 comprises two separate portions disposed along either side of the second portion 520. In this manner, the third portion 530 does not need to surround the distal end 522 of the second portion. The label 500 may be adhered to an article with the second major surfaces of the third portion 530 coated with adhesive, while the first and second portion 520 remain unadhered to the article.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A foldable label comprising:
a first portion including a first length defined between a fold end and a distal end of the first portion and a first width defined by opposing sides of the first portion,
a second portion including a second length defined between a fold end and a distal end of the second portion and a second width defined by opposing sides of the second portion, and wherein a fold line is defined between the first portion and the second portion proximate their respective fold ends; and
a third portion attached to the opposing sides of the second portion.

2. The label of claim 1, wherein the second length is substantially equal to the first length, and the second width is substantially equal to the first width.

3. The label of claim 1, wherein the third portion is attached to the second portion by a stress concentration region.

4. The label of claim 3, wherein the stress concentration region comprises at least one of perforations or a die-stamped area.

5. The label of claim 1, wherein fold line comprises a stress concentration region.

6. The label of claim 5, wherein the stress concentration region comprises at least one of perforations or a die-stamped area.

7. The label of claim 1, wherein the third portion surrounds and is attached to the opposing sides and the distal end of the second portion.

8. The label of claim 1, further comprising a fourth portion, disposed between the first portion and the second portion.

9. The label of claim 8, wherein the fold line extends from opposing sides of the fourth portion.

10. The label of claim 9, wherein the fourth portion is attached to the second portion, and wherein the fourth portion is not attached to the first portion.

11. The label of claim 10, wherein the fourth portion is attached to the second portion at a stress concentration region comprising perforations.

12. The label of claim 1, wherein the first portion, the second portion, and the third portion each comprise an indicia receiving major surface and a second major surface opposite the indicia receiving major surface, wherein the second major surface of the third portion comprises an adhesive.

13. The label of claim 12, wherein in response to the label being folded along the fold line, the second major surface of the first portion engages the second major surface of the second portion, and the adhesive major surface of the third portion is unobstructed.

14. The label of claim 13, further comprising an adhesive disposed on at least one of the second major surface of the first portion or the second major surface of the second portion.

15. The label of claim 14, wherein the second major surface of the first portion and the second major surface of the second portion are adhered to one another in response to the label being folded along the fold line.

16. The label of claim 12, wherein label is disposed on a continuous backing, and wherein the label is arranged with a plurality of other labels in a fan-fold configuration.

17. The label of claim 12, wherein label is disposed on a continuous backing, and wherein the label is arranged with a plurality of other labels in a spool configuration.

18. The label of claim 1, wherein the first portion, the second portion, and the third portion each comprise an indicia receiving major surface, wherein the indicia receiving major surface comprises a material adapted to receive a barcode.

19. A label folding apparatus comprising:
a label guide configured to be engaged by a label exiting a media processing device and to guide a first end of the label in a first direction;
a label stop arranged proximate the label guide, wherein the first end of the label is configured to engage the label stop in response to the label being guided in a first direction; and
a label grasping region disposed proximate the label guide, opposite the label stop relative to the label guide, wherein the label grasping region is configured to provide access to a fold line of a folded label.

20. The label folding apparatus of claim 19, wherein the label guide comprises a curved surface along which the label exiting the media processing device is guided.
